(19) United States
(12) Patent Application Publication
(10) Pub. No.: US 2017/0177773 A1
(43) Pub. Date: Jun. 22, 2017

(54) METHOD FOR TRANSLATING DOMAIN-SPECIFIC FUNCTIONAL MODELS TO SIMULATION MODELS

(71) Applicant: Siemens Aktiengesellschaft, Munich (DE)

(72) Inventors: Arquimedes Martinez Canedo, Plainsboro, NJ (US); Wolfram Klein, Neubiberg (DE); Robin Burger, Friolzheim (DE); Philippe Labalette, Karlsruhe (DE)

(21) Appl. No.: 14/970,569

(22) Filed: Dec. 16, 2015

(51) Int. Cl. G06F 17/50

(52) U.S. Cl. CPC G06F 17/5036

(57) ABSTRACT

A method for translating domain-specific functional models to simulation models that provide simulation of physical domains. The method includes providing an overall domain of a behavior and subdividing the overall domain into a plurality of subdomains to define domain-specific behavior. The method also includes subdividing the subdomains into a plurality of single functional components to form domain-specific components and subdividing the single functional components into a plurality of atomic functional components to form atomic domain-specific components. In addition, the method includes providing transfer functions between the subdomains, single functional components and atomic functional components. Further, the method includes providing a simple functional template for each atomic domain functional component and each domain-specific component, combining the atomic functional components to provide at least one simulation of an associated domain-specific system and combining the domain-specific behaviors to provide at least one simulation of an overall system.

### BACKGROUND

Technical Field

Aspects of the invention relate to multi-domain modeling and simulating systems that provide simulation across multiple physical domains, and more particularly, to a method for translating a domain-specific functional model to at least one simulation model by utilizing a simulation template library that is based on simplified simulation components that address one domain-specific function at a time.

Description of Related Art

The design of a system architecture that satisfies a set of requirements frequently requires a group of skilled technical personnel such as engineers or system designers. In particular, the system designers develop and compare several alternative system architectures as part of a manual develop-evaluate-validate cycle that occurs early in the design process. This cycle is often referred to as “system architecture benchmarking” and may take several months to complete. For each system architecture, a system designer must first develop a “functional structure” that reflects the number, type and connectivity between abstract functional components such as a piezo-electric device, piston, valve and other components. Once functional structures are built for each system architecture, the designer evaluates and eliminates designs that, according to their expertise, will not satisfy a set of given requirements (e.g., are too dangerous, do not meet specification and others).

At the end of the evaluation process, only a handful of system architectures remain which then go through a more rigorous validation using simulation models. A purpose of validation through simulation is to identify the best performing system architecture that satisfies all requirements. Simulation models typically include interconnected simulation components that describe a system behavior hierarchically.

Referring to FIG. 1, a method 10 for simulation model development is shown. The design of a new architecture for the process industry, for example, begins with the generation of a domain-specific functional structure 12 through the use of a functional editor 14 by a system designer 16. Functions (e.g., blocks) and flows (e.g., interconnections between functions or blocks) are instantiated from a domain-specific functions and flows library 18 that includes common functions typically used in a specific domain. By way of example, such libraries are available in diagramming software such as Microsoft Visio® sold by Microsoft Corporation of Redmond, Wash., US.

The domain-specific functional structure 12 is typically a document that includes functional models that use symbols, instead of words (verb-noun pairs), to represent the functionality of a system or component. The symbols are widely accepted by system designers and include pictorial representations to express the design intent of a system. The domain-specific functional structure 12 is provided to a user such as a simulation expert 20 or other personnel. The simulation expert 20, via a simulation tool 22, then selects simulation components from a simulation component library 25 that simulate or fulfill the functions in the domain-specific functional structure 12 so as to generate at least one simulation model 24. Each simulation model 24 is used to obtain simulation results 26 that are fed back to the simulation expert 20 for comparison with other results from alternative simulation designs. The simulation expert 20 then generates benchmarking results 28 which are then fed back to the system designer 16 at which time adjustments or changes are made to the architecture and/or the architecture is optimized. A disadvantage with this approach is that the mapping of functions to simulation components is a many-to-many relationship (i.e., N:M) mapping problem that provides a plurality of alternative realizations. In order to narrow that available number of realizations, the simulation expert 20 applies heuristics to create a simulation model 24 that satisfies both the domain-specific functional structure 12 and is compliant with simulation tool 22 syntax and semantics.

Functional structures may be defined as hierarchies of functional models known as functional decompositions. Referring to FIG. 2, a functional decomposition 30 of a domain-specific functional structure 32 of an exemplary pneumatic subsystem is shown. The functional structure 32 includes exemplary P_{Z} 34, U_{A} 36 and U_{B} 38 inputs, Y1 48, EXIT 50, Y2 52, Purge 54 and Venting 56 outputs, exemplary domain-specific functions such as filter 58, pressure regulator 60, piston 62 functions and others along with exemplary flows 64 that connect the functions. In a domain-specific functional structure, functions are identified by symbols rather than by using text. A benefit of this approach is that system designers in a particular domain understand the implicit functions fulfilled by a well specified domain-specific component (e.g., a piezo-electric component performs the functions of “convert electrical energy to translational mechanical energy” as well as “low voltage electromechanical interaction”). Domain-specific functional structures are therefore more compact and more useful for system designers that are familiar with a particular domain since such structures condense functional information into fewer functions.

FIGS. 3A and 3B depict exemplary first 66 and second 68 simulation model realizations, respectively, based on the domain-specific functional structure 32 shown in FIG. 2. The first 66 and second 68 simulation model realizations are alternative simulation model realizations. The first simulation model 66 uses relatively fewer components than the second simulation model 68 and thus provides a relatively lower detail realization of the functional structure. The alternative second simulation model 68 provides a higher detail realization of the functional structure since this model uses relatively more components that the first simulation model 66. Thus, although both the first 66 and second 68 simulation models provide information regarding electrical, pneumatic, and mechanical functions, the second simulation model 68 provides a more in-depth understanding in terms of functions and other parameters. It is understood that the first 66 and second 68 simulation models shown in FIGS. 3A and 3B are only two of a plurality of alternative simulation models that may be generated based on the domain-specific functional structure 32 shown in FIG. 2.

However, the quality of the resulting simulation model 24 may vary depending on the experience, ability, and understanding of the simulation expert 20. In addition, a configuration for a simulation model 24 developed for the same domain-specific functional structure may vary depending on the simulation expert 20 even though the same components are used. Further, the system designer 16 is not in full control of the process and must coordinate with the simulation expert 20. As such, the process becomes cumbersome for both the system designer 16 and the simulation expert 20 and leads to delays and miscommunication. This frequently results in a simulation model that does not fully represent the functionality described in the functional structure. Additionally, the manual mapping of functions to simulation components is error prone and time consuming. In particular, each time the domain-specific functional structure is modified, the simulation expert 20 must make corresponding manual changes to the simulation model 24 which leads to further delays and miscommunication.

### SUMMARY

A method for translating a domain-specific functional model to at least one simulation model by utilizing a simulation template library that is based on simplified simulation components that address one domain-specific function at a time. In particular, the method includes providing an overall domain of a behavior and subdividing the overall domain into a plurality of subdomains to define domain-specific behavior. The method also includes subdividing the subdomains into a plurality of single functional components to form domain-specific components and subdividing the single functional components into a plurality of atomic functional components to form atomic domain-specific components. In addition, the method includes providing transfer functions between the subdomains, single functional components and atomic functional components. Further, the method includes providing a simple functional template for each atomic domain functional component and each domain-specific component, combining the atomic functional components to provide at least one simulation of an associated domain-specific system and combining the domain-specific behaviors to provide at least one simulation of the overall system.

Those skilled in the art may apply the respective features of aspects of the present invention jointly or severally in any combination or sub-combination.

### BRIEF DESCRIPTION OF THE DRAWINGS

The teachings of several aspects of the present invention can be readily understood by considering the following detailed description in conjunction with the accompanying drawings, in which:

FIG. 1 depicts a method for simulation model development.

FIG. 2 depicts a domain-specific functional structure of an exemplary pneumatic subsystem functional model.

FIGS. 3A and 3B depict exemplary first and second simulation model realizations, respectively, based on the domain-specific functional structure shown in FIG. 2.

FIG. 4 depicts a method for translating a domain-specific functional model to at least one simulation model in accordance with aspects of the present invention.

FIG. 5 shows a table depicting exemplary mapping between domain-specific functions and simulation component alternatives.

FIG. 6 depicts an example of a domain-specific functional model having spring, piston and piezo-electric component domain-specific functions.

FIGS. 7A and 7B depict exemplary first and second alternative simulation model realizations, respectively, based on the domain-specific functional structure shown in FIG. 6.

FIG. 8 depicts a method for classifying and structuring an overall domain in accordance with aspects of the invention.

FIG. 9 depicts the method shown in FIG. 8 as applied to a pneumatic valve used in the process industry.

FIG. 10 depicts a method for defining and developing singular simulation component templates.

FIG. 11 illustrates a high level block diagram of a computer system.

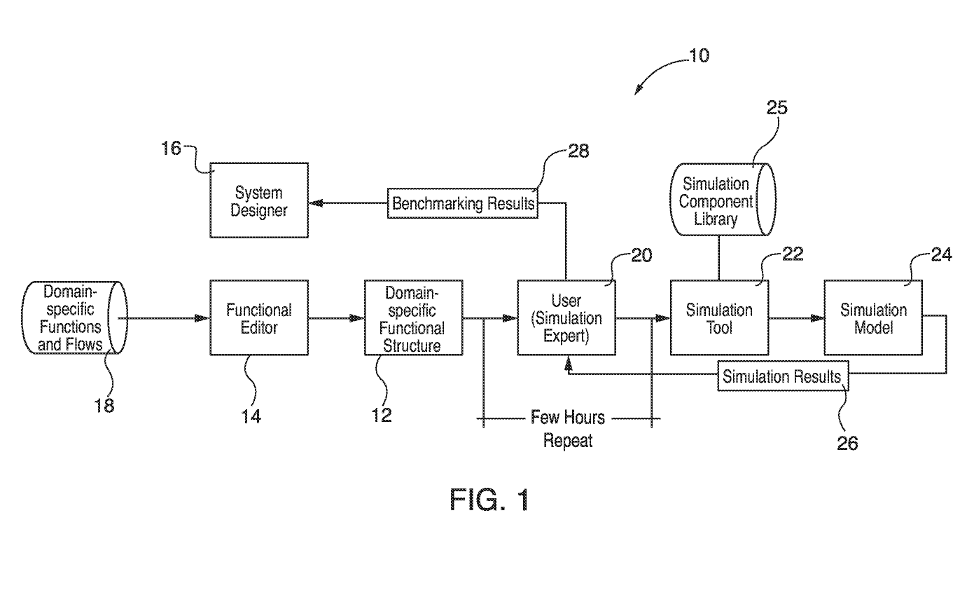

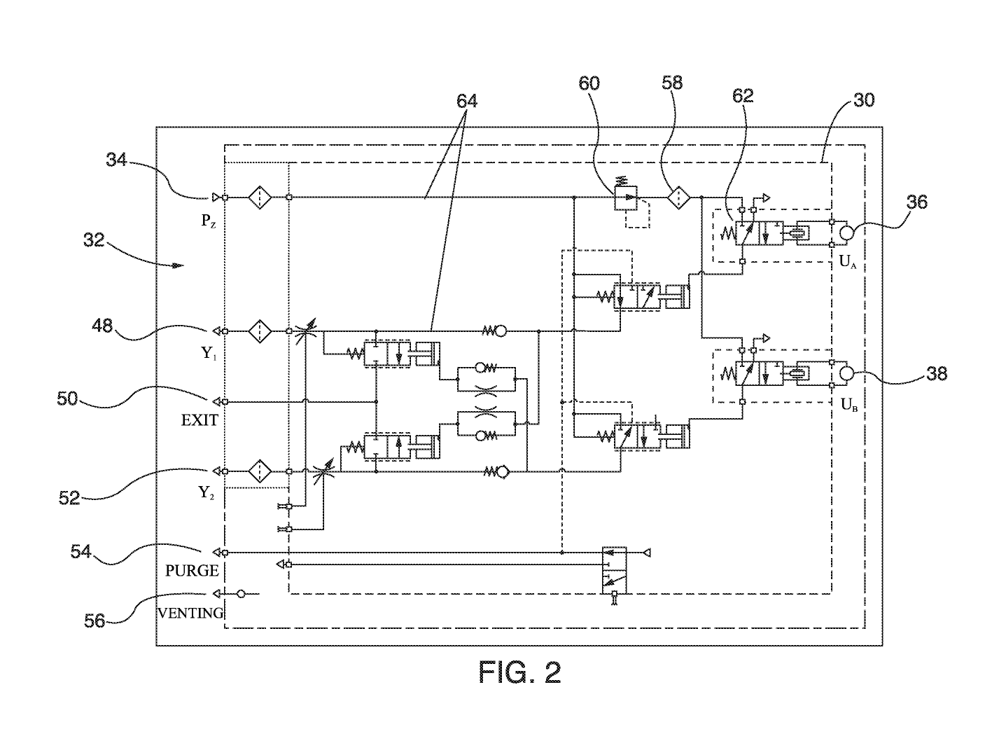

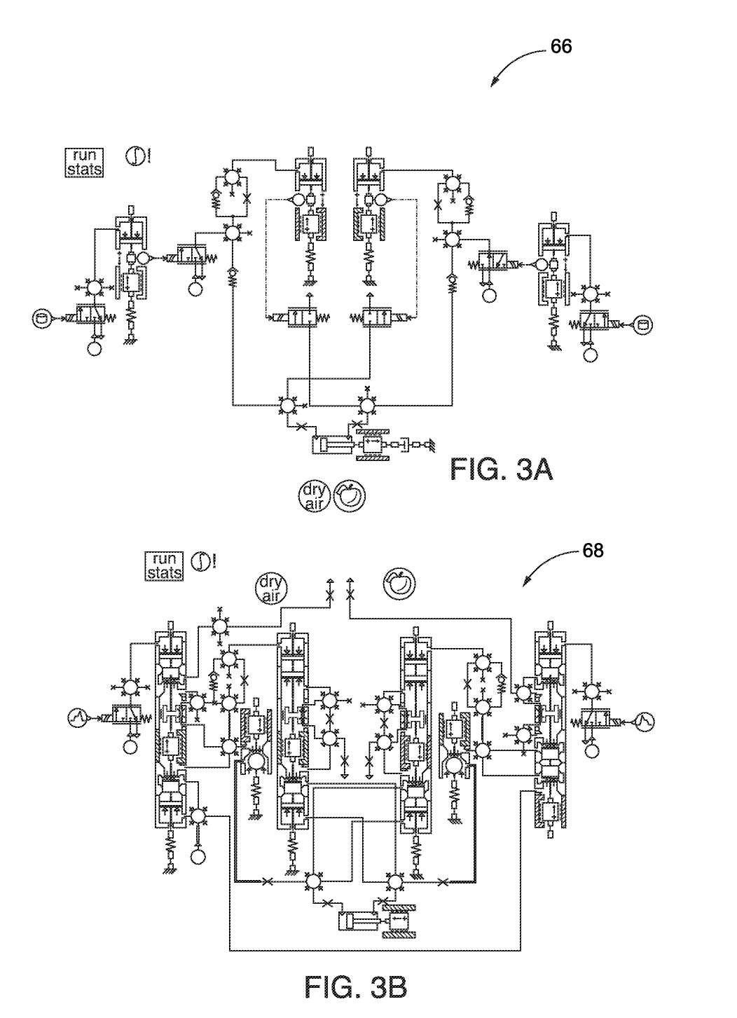

To facilitate understanding, identical reference numerals have been used, where possible, to designate identical elements that are common to the figures.

### DETAILED DESCRIPTION

Although various embodiments that incorporate the teachings of aspects of the present invention have been shown and described in detail herein, those skilled in the art can readily devise many other varied embodiments that still incorporate these teachings. Aspects of the invention are not limited in its application to the exemplary embodiment details of construction and the arrangement of components set forth in the description or illustrated in the drawings. Aspects of the invention are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Aspects of the present invention are utilized in conjunction with multi-domain modeling and simulating systems that provide simulation across multiple physical domains including electrical, mechanical, thermal, pneumatic and electromechanical physical domains and others at the system, subsystem and component levels such as the LMS Imagine.Lab Amesim™ mechatronic simulation environment available from Siemens PLM Division of Plano, Tex., US. Also, the disclosure of U.S. Patent Publication No. 2015/0081254 A1, published Mar. 19, 2015 and entitled METHOD FOR SYNTHESIS OF MULTI-FIDELITY SIMULATION MODELS USING FUNCTIONAL OPERATORS to Arquimedes Martinez Canedo is hereby incorporated by reference in its entirety.

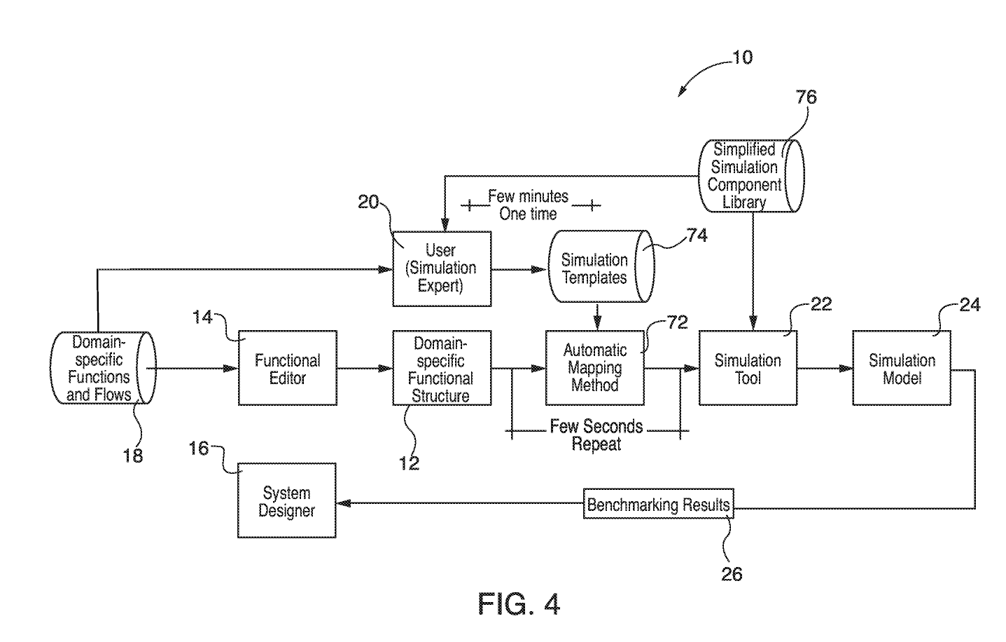

Referring to FIG. 4, a method 70 for translating a domain-specific functional model to at least one simulation model in accordance with aspects of the present invention is shown. For purposes of illustration, aspects of the present invention will be described in connection with the process industry, such as the oil, gas, food and beverage industries, although it is understood that aspects of the present invention are also applicable to other industries. The method 70 includes an automatic mapping method 72 that maps from the domain-specific functional structure 12 as previously described to a simulation model 24 via the simulation tool 22. The automatic mapping method 72 utilizes a simulation template library 74 that is based on a simplified simulation component library 76 having simplified simulation components developed by a simulation expert or other skilled personnel. The simplified simulation components address only one domain-specific function at a time and thus are substantially simpler than complete system models. Further, the domain-specific functions and the simplified simulation components have compatible interfaces to enable configuration and mapping of the simulation components and domain-specific functions. For example, a function such as “controlling the flow of a fluid” (e.g., a function for a valve) includes “fluid flow” as an interface. A search is then conducted for simplified simulation components that have an interface or a port for “pressure and flow rate variables”, resulting in the selection of a valve. In accordance with aspects of the present invention, a simulated system corresponding to the domain-specific functional structure 12 is generated by using simplified simulation components from the simplified simulation component library 76.

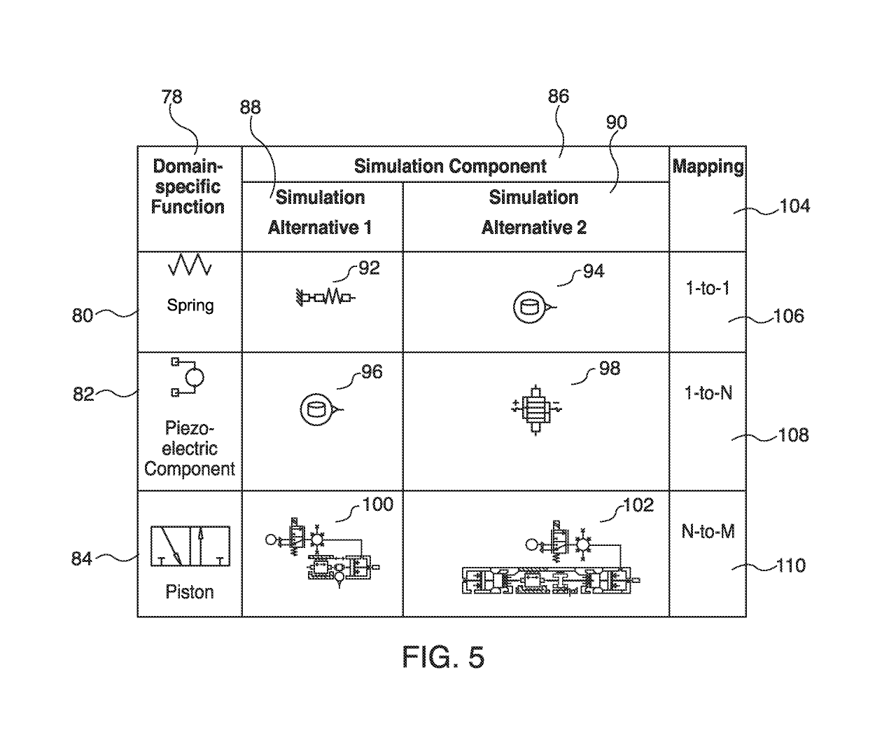

FIG. 5 shows a table depicting exemplary mapping between domain-specific functions and simulation component alternatives. In particular, FIG. 5 includes a domain-specific function column 78 having exemplary symbols for spring 80, piezo-electric component 82 and piston 84 domain-specific functions. A simulation component portion 86 includes readable icons for first 88 and second 90 simulation alternatives corresponding to an associated domain-specific function 80, 82, 84. Specifically, FIG. 5 depicts alternative first 92 and second 94 spring simulation components that correspond to the spring domain-specific function 80, alternative first 96 and second 98 piezo-electric simulation components that correspond to the piezo-electric domain-specific function 82 and alternative first 100 and second 102 piston simulation components that correspond to the piston domain-specific function 84. It is noted that the first 88 and second 90 simulation alternatives are exemplary and that a plurality of simulation alternatives may be generated for the domain-specific functions 80, 82, 84. Therefore, there may be a plurality of alternative spring simulation components that correspond to the spring domain-specific function 80, a plurality of alternative piezo-electric simulation components that correspond to the piezo-electric domain-specific function 82 and a plurality of alternative piston simulation components that correspond to the piston domain-specific function 84. A mapping column 104 shows that the mapping relationship from the spring domain-specific function 80 to the first 92 and second 94 spring simulation components is one-to-one (1-to-1) 106, the piezo-electric domain-specific function 82 to the first 96 and second 98 piezo-electric simulation components is one-to-many (1-to-N) 108 and the piston domain-specific function 84 to the first 100 and second 102 piston simulation components is many-to-many (N-to-M) 110. It is noted that all mappings are valid if the domain-specific functions and the simplified simulation components have compatible interfaces as previously described. In particular, each icon includes ports having at least one input and at least one output and mapping may be performed by linking an input of one icon to the output of another icon, for example. In addition, selection of a simulation component from FIG. 5 in conjunction with having a compatible interface results in automatic mapping.

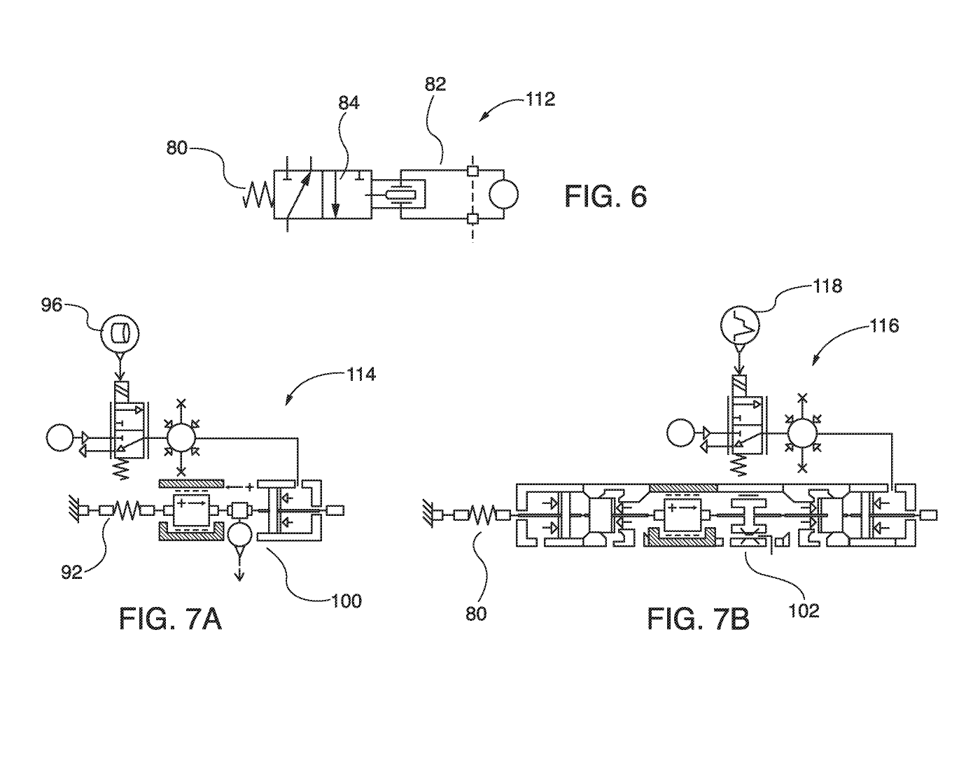

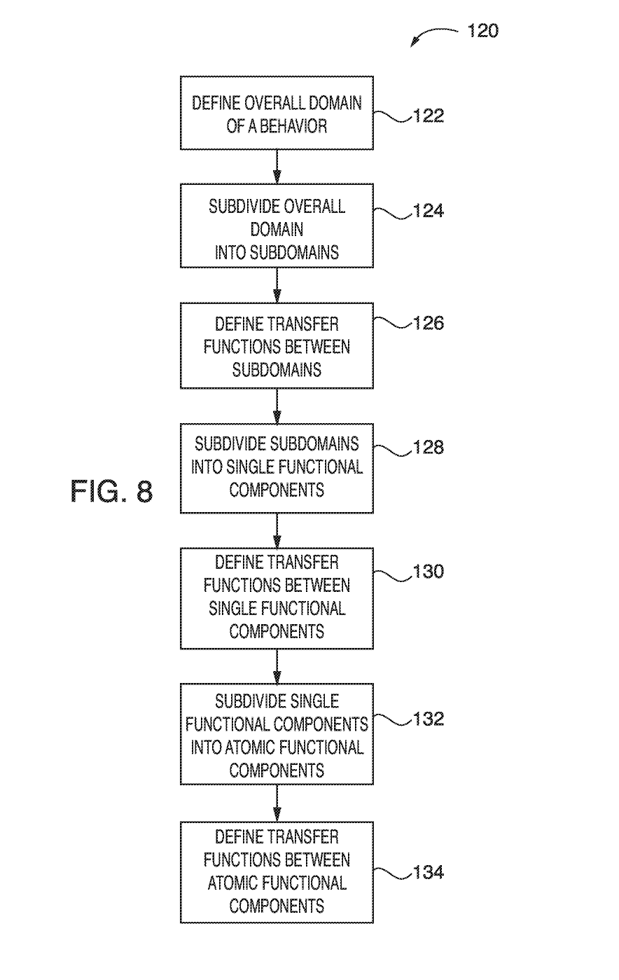

FIG. 6 depicts an example of a domain-specific functional model 112 having spring 80, piston 84 and piezo-electric component 82 domain-specific functions. FIGS. 7A and 7B depict exemplary first 114 and second 116 alternative simulation model realizations, respectively, based on the domain-specific functional model 112 shown in FIG. 6. In order to generate the first 114 and second 116 alternative simulation models, corresponding icons in FIG. 5 corresponding to a domain-specific function 80, 82, 84 are selected. In particular, the first simulation model 114 shown in FIG. 7A includes the first spring simulation component 92, the first piston simulation component 100 and the first piezo-electric simulation component 96. In addition, the second simulation model 116 shown in FIG. 7B includes the first spring simulation component 92, the second piston simulation component 102 and an additional piezo-electric simulation component 118 that represents piezo-electric behavior as a function of time (i.e. a third alternative piezo-electric simulation component 118). In accordance with aspects of the present invention, the first 114 and second 116 simulation models shown in FIGS. 7A and 7B, respectively, are functionally equivalent to the domain-specific functional model 112 shown in FIG. 6, and to each other, but the second simulation model 116 provides a more detailed simulation of the pneumatics and the mechanical aspects of the piezo-electric component and the piston, respectively. By way of example, the first simulation model 114 may be used to provide a preliminary assessment of a system whereas the second simulation model 116 may be used for more detailed analysis of a system. It is noted that the first 114 and second 116 simulation models shown in FIGS. 7A and 8B are only two of a plurality of alternative simulation models that may be generated based on the domain-specific functional model 112 shown in FIG. 6.

Referring to FIG. 8, a method 120 for classifying and structuring an overall domain in accordance with aspects of the invention is shown. At step 122, an overall domain of a behavior, such as the behavior of a pneumatic valve, is defined. At step 124, the overall domain is subdivided into subdomains that define domain-specific behavior. Next, suitable transfer functions are located between the subdomains and defined at step 126. The transfer functions serve to convert one type of energy to another type of energy so as to enable compatibility. At step 128, each subdomain is then subdivided into single, simple functional components to define domain-specific components. For example, this may include a control algorithm model of a smart positioner, a pneumatic model of the smart positioner, linear/rotary drive of a control valve a process valve and others. Next, suitable transfer functions are located between the single functional components and defined at step 130. The functional components are each subdivided into building block or atomic functional components to define atomic domain-specific components at step 132. The atomic functional components are used to create more complex simulation structures. For example, a resistor and a capacitor are atomic simulation components that may be arranged to create a low-pass filter component. In addition, various low-pass filters may be used to create signal processing applications. Further examples include linear/rotary drive of a control valve, air into chambers, atomic valves, pipes, masses and others. Further, transfer functions are located between the atomic functional components and defined at step 134.

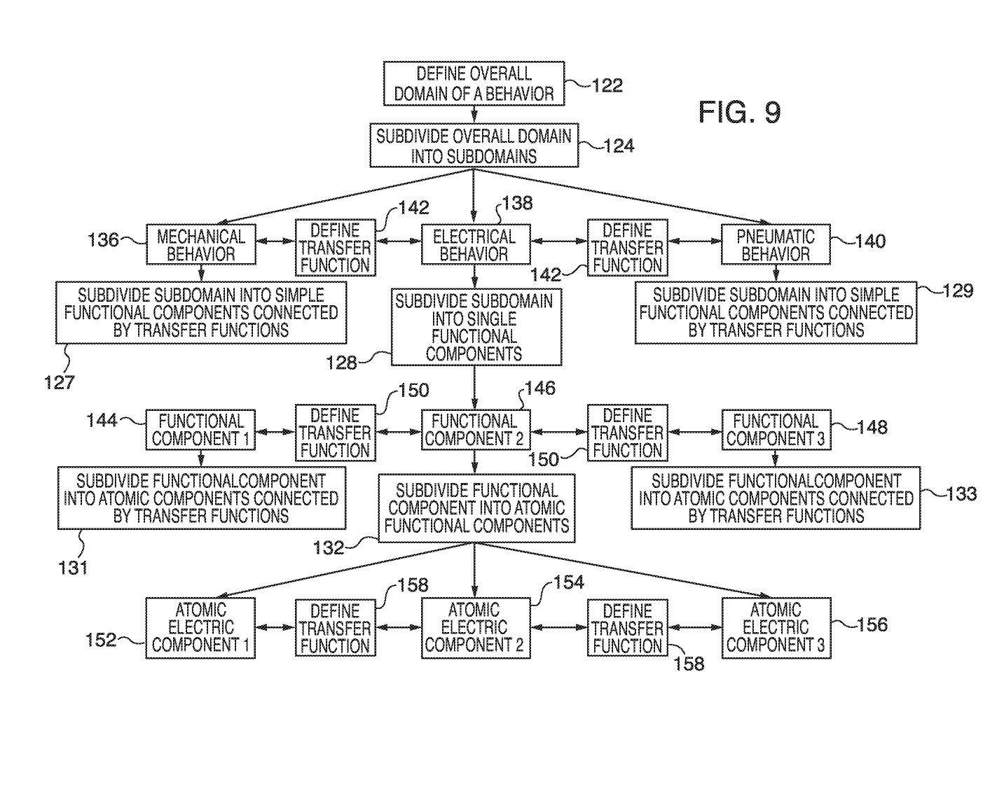

Referring to FIG. 9 in conjunction with FIG. 8, the method 120 will now be described in connection with a pneumatic valve used in the process industry. As previously described, the overall domain of a behavior a pneumatic valve is defined at step 122. With respect to step 124, the subdomains formed for a pneumatic valve may include a mechanical behavior subdomain at step 136, an electrical behavior subdomain at step 138 and a pneumatic behavior subdomain at step 140 that relate to mechanical, electrical and pneumatic behavior, respectively, of the valve. Transfer functions are then defined at step 142 that are located between the mechanical behavior subdomain at step 136 and electrical behavior subdomain at step 138 and between the electrical behavior subdomain at step 138 and the pneumatic behavior subdomain at step 140.

At step 128, the mechanical behavior subdomain at step 136, electrical behavior subdomain at step 138 and pneumatic behavior subdomain at step 140 are then divided into single functional components to define domain-specific components. For purposes of illustration, the method 120 will now be described in connection with the electrical behavior subdomain at step 138 although it is understood that the following description is also applicable to the mechanical behavior subdomain at step 136 and pneumatic behavior subdomain at step 140. The electrical behavior subdomain at step 138 is divided into first, second and third functional components at steps 144, 146 and 148, respectively. For example, this may include a control algorithm model of a smart positioner, a pneumatic model of the smart positioner, linear/rotary drive of a control valve a process valve and others. In addition, transfer functions are then defined at step 150 and located between the first and second functional components at steps 144 and 146, respectively, and between the second and third functional components at steps 146 and 148, respectively. In addition, mechanical behavior subdomain at step 136 and pneumatic behavior subdomain at step 140 are each subdivided into simple functional components connected by transfer functions at step 127 and 129, respectively, as previously described.

For purposes of illustration, the method 120 will now be described in connection with the second functional component at step 146 although it is understood that the following description is also applicable to the first and third functional components at steps 144 and 148, respectively. The second functional component at step 146 is subdivided at step 132 into building block or atomic functional components to define first, second and third atomic electric components at steps 152, 154 and 156, respectively. The first, second and third atomic electric components are used to create more complex simulation structures as previously described. Further, transfer functions are then defined at step 158 and located between the first and second atomic electric components at steps 152 and 154, respectively, and between the second and third atomic electric components at steps 154 and 156, respectively. In addition, the first and third functional components at steps 144 and 148 are each subdivided into atomic components connected by transfer functions at steps 131 and 133, respectively, as previously described.

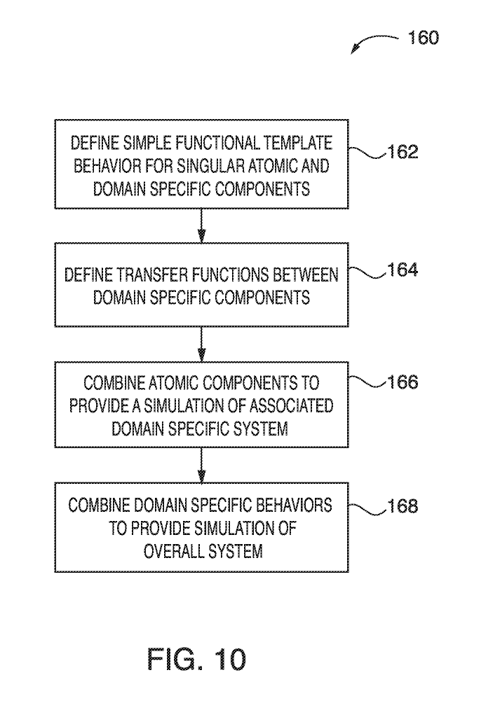

Referring to FIG. 10, a method 160 for defining and developing singular simulation component templates is shown. At step 162, a simple functional template behavior in combination with a clearly defined interface (e.g., input variables, output variables), and realized in a given simulation environment, is defined for the singular atomic and domain-specific components generated as a result of method 120 described above with respect to FIG. 8. The functional template behavior may be adjustable by using clearly defined parameters. For example, this may include configurable parameters that do not change during operation, such as an orifice diameter of a valve or stroke length of a piston. At step 164, transfer functions between domain-specific components are defined and developed. At step 166, atomic components are combined to provide a simulation of an associated domain-specific system. In particular, several different behaviors of different design alternatives or different granularity for the domain-specific behavior may be tested at this step. For example, different types of atomic components, such as different types of batteries, may be tested. At step 168, a plurality of domain-specific behaviors is combined to provide a simulation of the overall system. Several different behaviors of different design alternatives or different granularity for the entire behavior can also be tested at this step. For example, exemplary first 114 and second 116 alternative simulation model realizations, respectively, described in relation to FIGS. 7A and 7B, may be tested.

In particular, method 120, previously described in relation to FIG. 8, results in the generation of a plurality of components such as atomic components. Method 160 describes how the components are combined according to functional connections and associated ports (for example, first piston simulation component 100 and the first piezo-electric simulation component 96 shown in FIG. 7A) to provide a simulation model.

In accordance with aspects of the present invention, the fidelity and coverage of the simulations can be extended incrementally. In addition, creating simple simulation components is substantially less complicated than creating complete system models, thus reducing the amount of time needed to complete a model (e.g. a few minutes per model instead of hours per model). Further, the simplified simulation components in the simulation template library 74 may be reused by the personnel that developed the simplified simulation components and also by others in an organization. Additionally, the system designer 16 can compose simulation models without being a simulation expert.

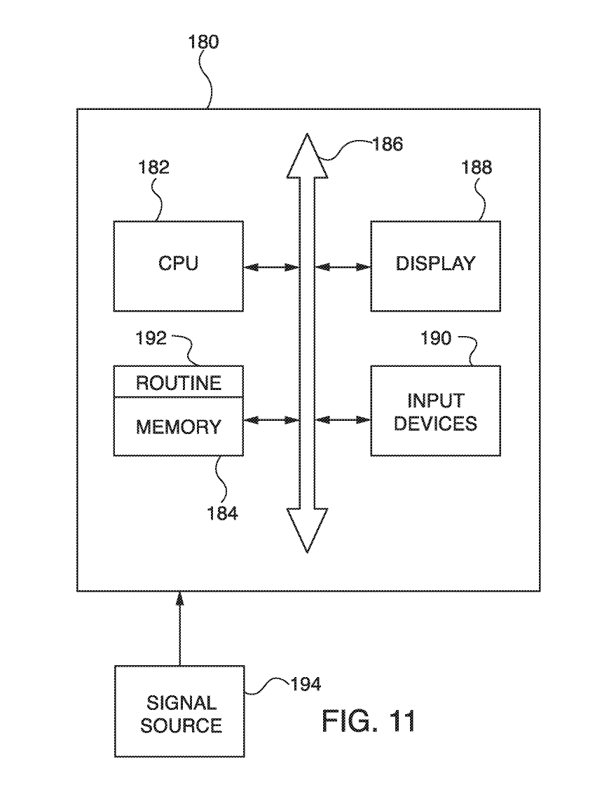

Aspects of the present invention may be implemented in various forms of software, firmware, special purpose processes, as an application program tangibly embodied on a computer readable program storage device or combinations thereof. The application program can be uploaded to, and executed by, a machine comprising any suitable architecture. Aspects of present invention may be implemented by using a computer system. A high level block diagram of a computer system 180 is illustrated in FIG. 11. The computer system 180 may use well known computer processors, memory units, storage devices, computer software and other components. The computer system 180 can comprise, inter alia, a central processing unit (CPU) 182, a memory 184 and an input/output (I/O) interface 186. The computer system 180 is generally coupled through the I/O interface 186 to a display 188 and various input devices 190 such as a mouse and keyboard. The support circuits can include circuits such as cache, power supplies, clock circuits, and a communications bus. The memory 184 can include random access memory (RAM), read only memory (ROM), disk drive, tape drive, etc., or a combination thereof. Aspects of the present invention can be implemented as a routine 192 that is stored in memory 184 and executed by the CPU 182 to process a signal from a signal source 194. As such, the computer system 180 is a general-purpose computer system that becomes a specific purpose computer system when executing the routine 192 in accordance with aspects of the present invention. The computer system 180 can communicate with one or more networks such as a local area network (LAN), a general wide area network (WAN), and/or a public network (e.g., the Internet) via a network adapter. In addition the computer system 180 may be used as a server as part of a cloud computing system where tasks are performed by remote processing devices that are linked through a communications network. In a distributed cloud computing environment, program modules may be located in both local and remote computer system storage media including memory storage devices.

The computer system 180 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device. Examples of well-known computing systems, environments, and/or configurations that may be suitable for use with computer system 180 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

It is to be further understood that, because some of the constituent system components and method steps depicted in the accompanying figures may be implemented in software, the actual connections between the system components (or the process steps) may differ depending upon the manner in which aspects of the present invention are programmed. Given the teachings of aspects of present invention provided herein, one of ordinary skill in the related art will be able to contemplate these and similar implementations or configurations of aspects of the present invention.

The system and processes of the figures are not exclusive. Other systems, processes and menus may be derived in accordance with aspects of the invention to accomplish the same objectives. Although aspects of the present invention have been described with reference to particular embodiments, it is to be understood that the embodiments and variations shown and described herein are for illustration purposes only. Modifications to the current design may be implemented by those skilled in the art, without departing from the scope of the aspects of the present invention. As described herein, the various systems, subsystems, agents, managers and processes can be implemented using hardware components, software components, and/or combinations thereof.

What is claimed is:

1. A method for translating domain-specific functional models to simulation models that provide simulation of a plurality of physical domains, wherein the domain-specific functional models correspond to an overall system having a plurality of domain-specific systems, comprising:
providing an overall domain of a behavior;
subdividing the overall domain into a plurality of subdomains to define domain-specific behavior;
subdividing the subdomains into a plurality of single functional components to form domain-specific components;
subdividing the single functional components into a plurality of atomic functional components to form atomic domain-specific components;
providing a simple functional template for each atomic domain functional component and each domain-specific component;
combining the atomic functional components to provide at least one simulation of an associated domain-specific system; and
combining the domain-specific behaviors to provide at least one simulation of the overall system.

2. The method according to claim 1, wherein the single functional components are included in a simulation template library.

3. The method according to claim 1, wherein the domain-specific behavior includes mechanical, electrical and pneumatic behaviors.

4. The method according to claim 1, wherein the overall domain includes behavior of a pneumatic valve.

5. The method according to claim 1, wherein the simulation of the overall system includes a plurality of simulation model alternatives.

6. The method according to claim 5, wherein the simulation model alternatives include first and second simulation model alternatives that are functionally equivalent to each other and wherein the second simulation model provides a more detailed simulation than the first simulation model.

7. The method according to claim 1, wherein the functional components include alternative first and second spring simulation components that correspond to a spring domain-specific function, alternative first and second piezo-electric simulation components that correspond to a piezo-electric domain-specific function and alternative first and second piston simulation components that correspond to a piston domain-specific function.

8. A method for translating domain-specific functional models to simulation models that provide simulation of a plurality of physical domains, wherein the domain-specific functional models correspond to an overall system having a plurality of domain-specific systems, comprising:
providing an overall domain of a behavior;
subdividing the overall domain into a plurality of subdomains to define domain-specific behavior;
subdividing the subdomains into a plurality of single functional components to form domain-specific components;
subdividing the single functional components into a plurality of atomic functional components to form atomic domain-specific components;
providing transfer functions between the subdomains, single functional components and atomic functional components;
providing a simple functional template for each atomic domain functional component and each domain-specific component;
combining the atomic functional components to provide at least one simulation of an associated domain-specific system; and
combining the domain-specific behaviors to provide at least one simulation of the overall system.

9. The method according to claim 8, wherein the single functional components are included in a simulation template library.

10. The method according to claim 8, wherein the domain-specific behavior includes mechanical, electrical and pneumatic behaviors.

11. The method according to claim 8, wherein the overall domain includes behavior of a pneumatic valve.

12. The method according to claim 8, wherein the simulation of the overall system includes a plurality of simulation model alternatives.

13. The method according to claim 12, wherein the simulation model alternatives include first and second simulation model alternatives that are functionally equivalent to each other and wherein the second simulation model provides a more detailed simulation than the first simulation model.

14. The method according to claim 8, wherein the functional components include alternative first and second spring simulation components that correspond to a spring domain-specific function, alternative first and second piezo-electric simulation components that correspond to a piezo-electric domain-specific function and alternative first and second piston simulation components that correspond to a piston domain-specific function.

15. A method for translating domain-specific functional models to simulation models that provide simulation of a plurality of physical domains, wherein the domain-specific functional models correspond to an overall system having a plurality of domain-specific systems, comprising:
providing an overall domain corresponding to a pneumatic behavior of a valve;
subdividing the overall domain into a plurality of subdomains to define domain-specific behavior, wherein the subdomains include mechanical, electrical and pneumatic behaviors of the valve;
subdividing the subdomains into a plurality of single functional components to form domain-specific components;
subdividing the single functional components into a plurality of atomic functional components to form atomic domain-specific components;
providing transfer functions between the subdomains, single functional components and atomic functional components;
providing a simple functional template for each atomic domain functional component and each domain-specific component;
combining the atomic functional components to provide at least one simulation of an associated domain-specific system; and
combining the domain-specific behaviors to provide at least one simulation of the overall system.

16. The method according to claim 15, wherein the single functional components are included in a simulation template library.

17. The method according to claim 15, wherein the simulation of the overall system includes a plurality of simulation model alternatives.

18. The method according to claim 17, wherein the simulation model alternatives include first and second simulation model alternatives that are functionally equivalent to each other and wherein the second simulation model provides a more detailed simulation than the first simulation model.

19. The method according to claim 15, wherein the functional components include alternative first and second spring simulation components that correspond to a spring domain-specific function, alternative first and second piezo-electric simulation components that correspond to a piezo-electric domain-specific function and alternative first and second piston simulation components that correspond to a piston domain-specific function.

20. The method according to claim 19, wherein a mapping relationship from the spring domain-specific function to the first and second spring simulation components is one-to-one, the piezo-electric domain-specific function to the first and second piezo-electric simulation components is one-to-many and the piston domain-specific function to the first and second piston simulation components is many-to-many.
